(19) United States
(12) Patent Application Publication
(10) Pub. No.: US 2007/0231058 A1
(43) Pub. Date: Oct. 4, 2007

(54) Rectangular binder with four sides and magnetic locks

(76) Inventors: Michel Vincent, Bussy Saint Georges (FR); Jacques Gerriet, Paris (FR)

Correspondence Address: HEDMAN & COSTIGAN P.C., 1185 AVENUE OF THE AMERICAS, NEW YORK, NY, 10036, US

(21) Appl. No.: 11/807,526

(22) Filed: May 29, 2007

Related U.S. Application Data
(63) Continuation-in-part of application No. 10/368,561, filed on Feb. 20, 2003.

(51) Int. Cl. B42F 13/00

(52) U.S. Cl. 402/74

(57) ABSTRACT

The binder comprises two faces, a back and two flaps respectively extending from a face and adapted to be folded to close the binder, an external envelope of transparent plastic material, a ring mechanism fixed inside the back, and a magnetic closure arranged on the flaps, this magnetic closure being constituted by a magnet positioned in a housing of the plastic envelope defining a flap, and a metallic plate positioned in a housing of the envelope defining the second flap with the plate and the first magnet having identical dimensions and are placed so that their perimeters coincide to be applied one against the other.

### PRIOR APPLICATION

This application is a continuation-in-part application of U.S. patent application Ser. No. 10/368,561 filed Feb. 20, 2003.

### STATE OF THE ART

In the state of the art, rigid binders are known which are provided with an assembly of rings for maintaining documents, and have a parallelepiped shape when they are closed and are equipped with closing means. Thus, for example, it is known to make a binder of the type comprising two faces connected by a back and provided with foldable flaps, equipped with snap fasteners making it possible to keep the binder closed.

Document DE-OS 24 20 803 describes a binder in which only one of the faces is provided with a foldable flap, in which are pierced passages associated with tongues arranged on the edge of the other face, which can be introduced in the passages to ensure the closing of the binder.

These closing means do not give entire satisfaction, because they necessitate manipulations that can be difficult. Moreover, closing means of the type with tongues or snap fasteners are necessarily located in very precise positions, and thus, they cannot ensure a continuous closure along the edges of the faces. As a result, the mechanical resistance of the closed binder is not as satisfactory as desired.

### OBJECTS OF THE INVENTION

It is an object of the invention to provide an improves binder for documents provided with an improved closing device that is more effective, is easier and faster to use, does not require difficult manipulations like snap fasteners and contributes to a better mechanical resistance of the binder.

It is a further object of the invention to provide a method of manufacturing the binder.

These and other objects and advantages of the invention will become obvious from the following detailed description.

### SUMMARY OF THE INVENTION

A binder for documents comprising two faces connected by a back and extended by respective flags foldable one over the other in a closed position of the binder which defines in this position a parallelepiped volume, a ring mechanism fixed inside the back or inside one of the faces to maintain documents, closing mans on the flaps wherein the said closing means comprises a magnet integral with one flap and a metallic element integral with the second flap whereby the magnet can be used to maintain the binder closed and a transparent plastic envelope enclosing the two faces, the back and the flap, the metallic element and the magnet. The back is equipped in a traditional way with metallic rings for the fixation of documents, and a personalized “crystal”, i.e., one or several transparent plastic sheets, can complete the binder.

According to the invention, the closing means comprise a magnet integral with a first flap and a metallic element integral with the second flap, on which the magnet can be applied to maintain the binder closed. The magnet and the associated metallic element being appropriately located and dimensioned, one understands that simply folding the flaps, without any other manipulation, is sufficient to ensure a good closure of the binder and its satisfactory resistance for organization purposes.

According to an embodiment of the invention, the magnet is a rectangular plate having dimensions substantially inferior to those of the associated flap, and the metallic element is a plate having dimensions equal to those of the magnet and substantially inferior to those of the second flap.

In a preferred embodiment of the invention, the closing means is a magnet in each flap opposite each other so when the flaps are in the closed position the magnets will attract each other to hold the flaps in the closed position. In a further embodiment, the 3 flaps are of different colors so that there can be a code so user can determine that work is to be done if one color flap shows or nothing to be done if the second color flap shows.

The process of manufacture, also provided by the invention, is characterized by the following stops;

a) laying a first sheet of plastic material on the surface plate of a tool, on which are marked respective housings for the corresponding faces, the back, the flaps, the magnet and the metallic plate,

b) laying the metallic plate on the part of the sheet defining the first housing corresponding to the first flap,

c) laying a first rigid face on the plastic sheet at the location of the second housing,

d) laying a rigid element forming the back on the location of the sheet defining the third housing,

e) laying a second face on the location corresponding to the fourth housing defined on the sheet,

f) laying the magnet on the part of the sheet defining the fifth housing corresponding to the second flap,

g) laying a second sheet of plastic material on the metallic plate, the flaps, the back and the magnet, this second sheet, as well as the first sheet, being dimensioned so as to be able to completely cover the faces, the back, and the flaps as well as the magnet and the metallic plate,

h) performing a welding operation over the entire perimeter of the two sheets of plastic material in order to close the plastic envelope.

After welding, the perimeter of the envelope is cleaned so as to trim it appropriately.

The welding is performed by any appropriate means, in particular with a high frequency device or with ultrasounds.

Other particularities and advantages of the invention will appear in the following description in reference to the annexed drawings illustrating a non-limitative exemplary embodiment.

### BRIEF DESCRIPTION OF THE DRAWINGS

FIG. 1 is a simplified perspective view representing the machine tool that make it possible to implement the process of manufacture of a binder according to the invention.

FIG. 2 is a top view of a sheet of plastic material in which have been marked the housings for the various parts constituting the binder and partially illustrating the implementation of its process of manufacture.

FIG. 3 is a perspective view, at a reduced scale, of a binder of the type covered by the invention showing the rings located on a face of the binder.

FIG. 4 is a top view of one of the open lateral parts of the binder in a variant with rings mounted in the back of the binder.

FIG. 5 is a perspective of the binder with a magnet on each flap.

The binder 1 shown in FIG. 3 comprises a first rigid face 2, a rigid back 3, a second rigid face 4, a first flap 5 extending the first face 2 and foldable with respect to the latter along a folding line 6, a second flap 7 extending the second face 4 and foldable with respect to the latter along a folding line 8. The folding lines 6 and 8 are also shown in FIG. 2.

A system of metallic rings 9, partially shown on FIG. 3 and a type known in itself, which do not necessitate a description, is fixed on the inside of the back 3 by rivets. The faces 2, 4 and the back 3 are made of a rigid material such as cardboard, and are contained inside an envelope of plastic material such as, for example, polyvinyl chloride PVC).

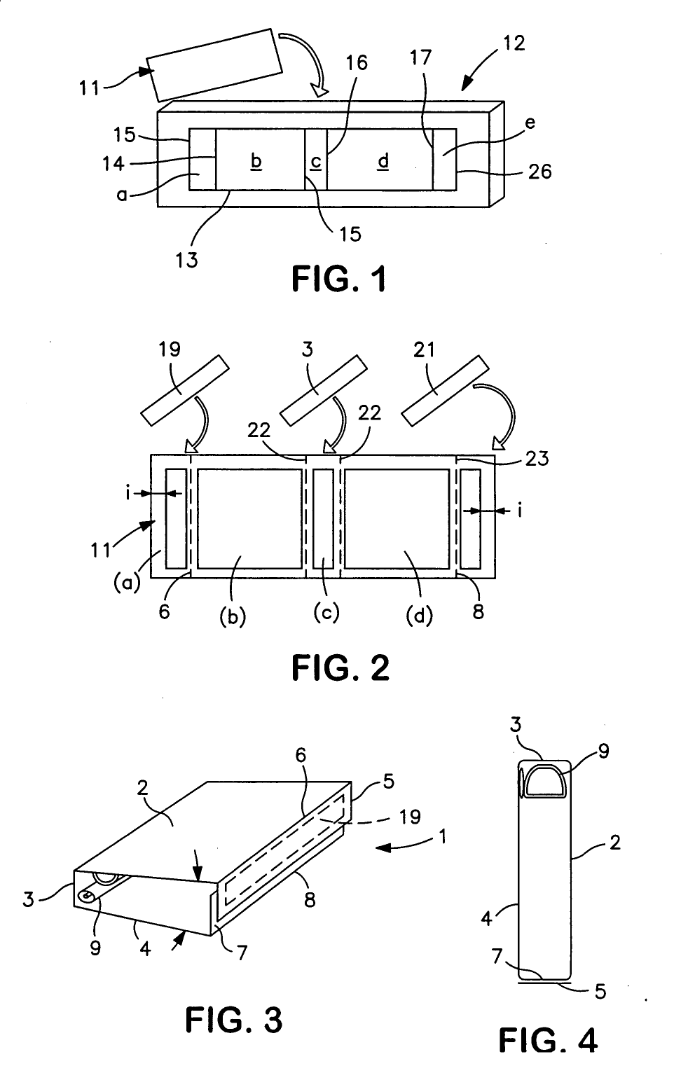

FIG. 1 shows one of 11 of the two plastic sheets from which the envelope is formed.

The machine tool 12 shown schematically on FIG. 1 is known in itself and does not require a detailed description. It comprises a base, on whose surface plate are located marks 13, 14, 15, 16, 17, 25 and 26 defining the perimeter of the binder 1, and a series of housings a-b-c-d-c respectively designed to define the first flap 5, the first face 2, the back 3, the second face 4 and the second flap 7.

The above marks are dashes which must define the flaps, the faces and the back of the binder 1 (FIG. 3).

The basic principle of high frequency welding is, as is known, molecular agitation by heating the parts in contact, combined with necessary and sufficient pressure. The part in contact is called “welding” and is associated to a “cutting” enabling cleaning of the perimeter of the envelope after welding over the perimeter of the plastic sheets.

Welding blades (welding/cutting) disposed on a plate are used, whose disposition reproduces faithfully the measured drawing of the product to be manufactured. The thickness of the welding blades is a function of the thickness of PVC to be assembled. It is also adapted to take into account the power of the generator as well as the welding time, i.e., the time during which the electrode is in contact with the PVC, but also the surface to be welded.

The welding time varies as a function of the heated state of the blades and the ambient temperature. It is adjusted during production after check-ups.

The binder 1, of the type having four sides, combines the advantages of the binder and of the organization box. It can in all cases stand upright, and thus, it is not subject to a risk of collapsing on the side opposed to the back 3 as can be observed with binders that are not provided with rigid and foldable flaps.

Closing of the binder 1 is performed by associating a metallic plate 19 located in the first flap 5 and a magnet 21 located in the second flap 8. The plate 19 and the magnet 21 have exactly identical dimensions, and are constituted, for example, as shown in FIG. 2, by rectangular plates whose dimensions are slightly inferior to those of the corresponding flaps 5 and 7, with lateral margins I to enable their positioning in their respective housings without difficulty.

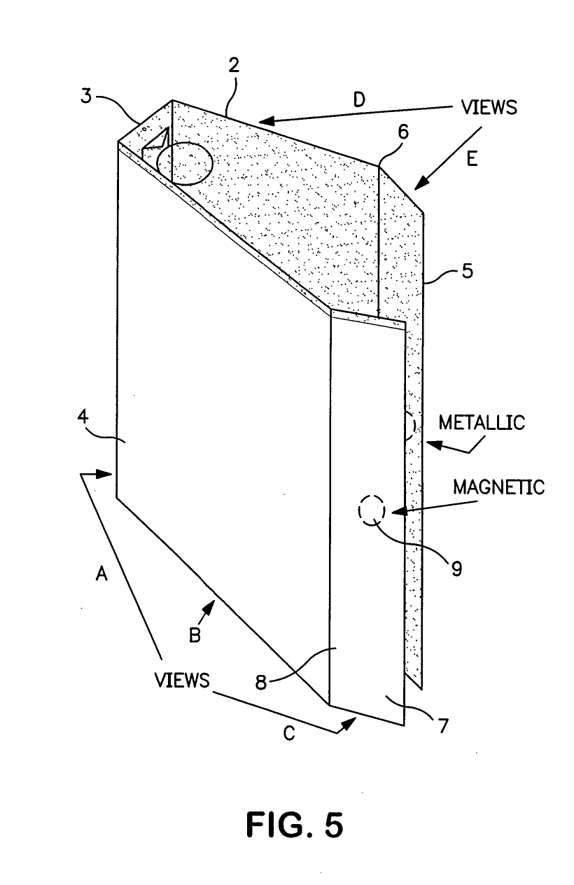

In the preferred embodiment of FIG. 5, the binder 1 comprises a first rigid face 2, a rigid back 3, a second rigid face 4, a first flap 5 extending from the first face 2 and foldable with respect thereto along a folding line 6, a second flap 7 extending from the second face 4 and foldable along a folding line 8. There is a magnet 9 in flap 7, a metal plate 10 in flap 5. The metal plate 10 can be the whole flap 5 or may be a portion of flap 5 opposite the magnet to keep flaps 5 and 7 closed. Optionally, side 2 and flap 7 may be of one color and side 4 and flap 7 may be of a second color so if flap 7 is exposed, it has one meaning i.e. work to be done and if flap 5 is exposed, it has a second meaning, i.e. work is completed.

The process of manufacture of the binder 1 is as follows:

It comprises three groups of steps: the cutting, the assembly, and the mounting:

a) One lays on the surface plate of the tool 12 (shown in perspective in FIG. 1 but disposed horizontally for the implementation of the process of manufacture) a first sheet 11 of plastic material such as PVC, cut to the final shape if the binder 1 with an appropriate peripheral extension, for example, 1 cm. This extension enables later cleaning, i.e., trimming by hand after welding of the perimeter of the PVC envelope.

The marks 13-17-25-26 constituting a preform on the tool 12 define housings a-b-c-d-e, respectively for the first flap 5, the first face 2, the back 3, the second face 4 and the second flap 7. These housings are defined on the sheet 11 by dot lines 6, 21, 22 and 23.

One cuts, optionally, a crystal (not shown) for personalizing the binder on the same format as the faces 2, 4, then one cuts rigid faces, preferably in cardboard, to form the first and second covers of the binder 1. One cuts cardboard parts to form the back 3 and the closing flaps 5, 7.

Finally, one cuts a magnet 21 to the format of one of the flaps, for example, the flap 7 (FIG. 2) and the metallic plate 19 to the exact format of the magnet 21.

One adjust the surface plate forming support plate of the product to the cutting format, and one performs the necessary preliminary adjustments.

b) One lays the rectangular metallic plate 19 on the part of the sheet 11 forming one of the faces of the housing a corresponding to the first flap (FIG. 2).

c) One lays a first rigid face, for example in cardboard, to the dimension of the final face 2, on the sheet 11 in the location b of its housing.

d) One lays a rigid element forming the back 3 on the location c corresponding to its housing, defined by marks 15, 16 on the tool 12 and by lines 21, 22 on the sheet 11.

e) One lays the second rigid face 4 on its location corresponding to housing d.

These various operations are symbolized by arrows on FIGS. 1 and 2.

f) One position is a closing cardboard part on which the magnet 21 is glued and then disposed on the location of the sheet 11 corresponding to the preformed housing e on the tool 12.

g) One lays a second plastic sheet, for example, in PVC like the sheet 11, on all the above elements, this second sheet having the same format as the first sheet 11.

h) One performs welding, by high frequency or by ultrasounds, over the perimeter of the two plastic sheets in order to form a closed envelope, containing all the above elements. This operation is performed in a manner known in itself by lowering a press not shown, and contact with the assembly that was just formed.

i) One raises the welding press and performs cleaning of the perimeter of the envelope, in order to trim it.

During the above process, the personalizing crystal of the binder 1 is positioned after the positioning of the cardboard part forming the first face 2.

The metallic plate 19 and the magnet 21 must be perfectly positioned one facing the other so that their perimeters coincide, as any discrepancy would lead to the creation of an electric are between the product and the tool, resulting in a partial, or even total, alteration of the tool.

The ring mechanism 9 is fixed in a manner known in itself which does not require a description.

As is visible in FIG. 2, the dimensions of the magnet 21 and of the associated plate 19 are substantially inferior to those of the corresponding flaps, so as to reserve lateral margins i between the edges of the elements 19, 21 and the outer edges of the flaps.

The invention is susceptible to various embodiments within the framework of the following claims. For example, the plate 19 and the magnet 21 can have shapes other than rectangular, or can be replaced by two or more plates and corresponding magnets of identical dimensions. Of course, the magnet 21 and the metallic plate can be placed in one or the other of the flaps 5, 7.

What we claim is:

1. Binder for documents, comprising:
two faces connected by a back and extended by respective flaps foldable one over the other in a closed position of the binder, which defines in this position a parallelepiped volume,
a ring mechanism fixed inside the back or inside one of the faces to maintain the documents, and
closing means arranged on the flaps,
wherein the closing means comprise a magnet integral with the first flap and a metallic element integral with the second flap, on which the magnet can be applied to maintain the binder closed, and
an envelope made of transparent plastic material containing the faces, the back, the flaps, the metallic element and the magnet.

2. Binder according to claim 1, wherein the magnet and the associated element are plates with identical dimensions, which are substantially inferior to dimensions of the corresponding flaps.

3. Binder according to claim 2, wherein the magnet and the metallic element are contained in respective housings defined by the flaps.

4. A process of the manufacture of a binder of claim 1, with an appropriately preformed tool defining on its support surface plate respective housings for various parts of the binder, comprising the following steps;
a) laying on the surface plate of the tool, a first sheet of plastic material on which are defined respective housings for corresponding faces, a back a magnet, and a metallic element,
b) laying the metallic element on a part of the sheet defining a first housing corresponding to a first flap,
c) laying a first face on the sheet in a location defining a second corresponding housing,
d) laying an element forming the back in a location of the sheet corresponding, in its center to a third housing,
e) laying a second face in a location of the sheet corresponding to a fourth housing,
f) laying a magnet on a respective flap in a location of a fifth housing,
g) laying a second sheet of plastic material with a format identical to that of the first sheet on all the above elements,
h) performing welding over the perimeter of the two sheets of plastic material in in order to form a closed envelope containing the faces, the back, the flaps, the metallic plate and the magnet,
i) performing cleaning over the perimeter of the envelope of plastic material to trim it and
j) providing a ring mechanism fixed inside the back or inside one of the faces to maintain documents.

5. Process according to claim 4, wherein the welding is performed with a high frequency device.

6. Process according to claim 4, wherein the welding is performed with ultrasounds.

7. Process according to claim 4, wherein the faces and the back are rigid.

8. Process according to claim 4, wherein the magnet and the metallic element are plates.

9. Process according to claim 4, wherein the magnet has a perimeter corresponding exactly to that of the associated metallic element.

10. A binder comprising two faces joined by a back, a flap extending from each face adapted to be folded to close the binder, a ring mechanism fixed inside the back, a magnetic closing means comprising a magnet in one of the flaps and a metal plate disposed in the other flap opposite the magnet to hold the flap closed.

11. The binder of claim 10 where one flap is of one colon and the second flap is a second color.
